(19) United States
(12) Patent Application Publication
(10) Pub. No.: US 2006/0215686 A1
(43) Pub. Date: Sep. 28, 2006

(54) Communication method for accessing wireless medium under enhanced distributed channel access

(75) Inventor: Shojiro Takeuchi, Tokyo (JP)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/268,814

(22) Filed: Nov. 7, 2005

Related U.S. Application Data
(60) Provisional application No. 60/665,945, filed on Mar. 28, 2005.

(51) Int. Cl. H04L 12/413

(52) U.S. Cl. 370/445

(57) ABSTRACT

A method to adaptively control CW sizes in order to enhance throughput of real-time traffic even when an AP accept large number of real-time traffic is disclosed. Since default CW sizes for real-time flows are set to small values in order to achieve the service differentiation, real-time flows cannot meet their requirements when collisions between real-time flows often occur. When increasing the size of CW in an AC, the one in other ACs are also increased if the service differentiation among ACs has to be maintained. And in case of decreasing the size of CW in an AC, the one in other ACs are also decreased if the service differentiation has to be maintained.

### CROSS-REFERENCE TO RELATED APPLICATIONS

This application claims priority under 35 U.S.C § 119 to U.S. provisional patent application No. 60/665,945 filed on Mar. 28, 2005, the contents of which are incorporated herein by reference in its entirety.

### FIELD OF THE INVENTION

The present invention relates to a communication method for accessing a wireless medium under carrier sense multiple access with collision avoidance (CSMA/CA), and more particularly to a method to enhance throughput of real-time traffic under enhanced distributed channel access (EDCA).

### BACKGROUND OF THE INVENTION

IEEE 802.11 WLAN technology has become very popular because of its advantage in price and bandwidth. Nowadays, WLAN is mainly used for Internet access, but real-time application like VoIP (Voice over IP) and video conference are identified as next killer applications for WLAN.

Since these applications require distinct specific features, such as delay sensitivity or bandwidth requirement, it is desired to support differentiation services in IEEE 802.11 standard. MAC (medium access control) protocol in the “Wireless LAN Medium Access Control (MAC) and Physical Layer (PHY) Specifications, IEEE Std 802.11-1999 (Reaff 2003)” employs a contention-based channel access, called DCF (distributed coordination function).

The DCF operates with CSMA/CA. However, the DCF does not work well with real-time applications due to that a STA (station), having real-time traffic, may wait for long time to access the WM (wireless medium) regardless of its requirement. When real-time traffic contends with best effort traffic, both of traffic has the same opportunity to access the WM. Therefore, real-time traffic, which has delay sensitivity, does not meet its requirement under DCF.

To overcome the problem presented above, IEEE 802.11e working group is now discussing new 802.11 MAC protocol, which provides QoS (Quality of Service). The 802.11e HCF (hybrid coordination function) can support QoS in 802.11 networks. The HCF provides both a contention-based channel access, called EDCA (enhanced distributed channel access), and a controlled channel access, referred to as HCCA (HCF controlled channel access).

The EDCA ensures that a STA with high priority traffic (i.e. traffic with real-time requirement) can have more opportunities to access the WM than low priority traffic transmitted from other STAs or itself. The EDCA achieves the service differentiation using different CW sizes and inter-frame spaces.

Comparing with the DCF, the EDCA can guarantee the service differentiation. But it does not completely meet requirement of high priority traffic. If an AP (access point) accepts a lot of flows, the network will become saturated and then they are suffered from performance degradation. To avoid excess accesses, the 802.11e supports an admission control scheme.

However, even though the EDCA provides both the service differentiation and the admission control, it does not fully protect high priority traffic. Since the EDCA provides contention-based channel access, contentions between high priority flows or between high and low priority flows degrade performance measures such as throughput or delay of real-time traffic. Therefore the present invention provides a method to enhance throughput of real-time traffic under EDCA.

Basically CW sizes for high priority traffic are smaller than low priority traffic so that high priority traffic gets more chance to access the WM. However, when a lot of high priority traffic associate with an AP, collisions between high priority traffic often happen due to small CW sizes. In order to overcome such problem, the present invention provides a method for an AP to dynamically control CW sizes.

### SUMMARY OF THE INVENTION

The algorithm according to the present invention which can be incorporated into wireless media such as WLAN (Wireless LAN) devices and WLAN STAs (stations) works to adaptively update a size of contention windows (CWs) in access categories (ACs) of the wireless media under Enhanced Distributed Channel Access (EDCA) in accordance with real-time traffic conditions.

The adaption algorithm sets default values first for CWₘᵢₙ[k] and CWₘₐₓ[k] in each AC[k], where k is an integer in a range of 0≦k≦3, when WLAN devices are turned on.

Then, the number of STAs having real-time flows whose transmission buffer is greater than zero is counted, followed by determining whether each size of CWs is necessary to be updated in accordance with the number of packets.

Then, it has to be determined which AC[3] or AC[2] increases or decreases its contention window sizes.

When updating them in AC[3] or AC[2], service differentiation defined in IEEE802.11e as a default is at least maintained. That is, ones in AC[1] and AC[0] are accordingly updated. Furthermore, minimum and maximum sizes of CW in an AC do not become equal to or smaller than those in other ACs for real-time traffic. When updating CW sizes in an AC, both minimum and maximum CW sizes in the AC are updated. However, maximum CW sizes both in AC[1] and AC[0] are not updated because they are set to a maximum value as a default value.

The below shows how to increase or decrease CW sizes in each AC when increasing or decreasing ones in AC[3] or AC[2].

In case of increasing CW sizes in AC[3], it has to be determined whether half of those in AC[2] are larger than the current ones in AC[3]. If such conditions are satisfied, only CWₘᵢₙ[3] and CWₘₐₓ[3] are increased. Otherwise, CWₘᵢₙ[2], CWₘₐₓ[2], CWₘᵢₙ[1] and CWₘᵢₙ[0] are also increased in addition to ones in AC[3].

In case of increasing CW sizes in AC[2], CWₘᵢₙ[1] and CWₘᵢₙ[0] are also increased in addition to ones in AC[2].

In any event, CWₘₐₓ[1] and CWₘₐₓ[0] are not updated because their default values are set as a maximum value.

In case of decreasing CW sizes in AC[3], it has to be determined which AC[3] or AC[2] decreases its contention window sizes.

In case of decreasing CW sizes in AC[3], CWₘᵢₙ[3] and CWₘₐₓ[3], CWₘᵢₙ[2], CWₘₐₓ[2], CWₘᵢₙ[1] and CWₘᵢₙ[0] are also decreased if CW sizes in AC[2] can be decreased.

In case of decreasing CW sizes in AC[2], it has to be determined whether half of CWₘᵢₙ[2] is larger than CWₘᵢₙ[3]. If such conditions are satisfied, CWₘᵢₙ[2], CWₘₐₓ[2), CWₘᵢₙ[1] and CWₘᵢₙ[0] are decreased.

If such conditions are not satisfied, any contention window sizes are not decreased.

The decreased CW sizes are not below the default values of CWₘᵢₙ[k].

This summary does not purport to define the invention. The invention is defined by the claims.

### BRIEF DESCRIPTION OF THE DRAWINGS

FIG. 1 is a wireless communication system between a wireless LAN access point (AP) and a plurality of wireless LAN stations (STA).

FIG. 2 is a system configuration showing an implementation model for EDCA.

FIG. 3 is a diagram showing an update policy in case of increasing CW sizes according to the present invention.

FIG. 4 is a diagram showing an update policy in case of decreasing CW sizes according to the present invention.

FIG. 5 is a diagram showing First Phase of the adaptation algorithm according to the first embodiment of the present invention.

FIG. 6 is a diagram showing Second Phase of the adaptation algorithm according to the first embodiment of the present invention.

FIG. 7 is a diagram showing First Phase of the adaption algorithm according to the second embodiment of the present invention.

FIG. 8 is a diagram showing Second Phase of the adaption algorithm according to the second embodiment of the present invention.

FIG. 9 is a diagram showing comparison of throughput of voice flow in Scenario 1.

FIG. 10 is a diagram showing comparison of throughput of video flow in Scenario 1.

FIG. 11 is a diagram showing comparison of throughput of voice flow in Scenario 2.

FIG. 12 is a diagram showing comparison of throughput of video flow in Scenario 2.

FIG. 13 is a diagram showing comparison of delay of voice flow in Scenario 2.

FIG. 14 is a diagram showing comparison of delay of video flow in Scenario 2.

### DETAILED DESCRIPTION OF THE PREFERRED EMBODIMENTS

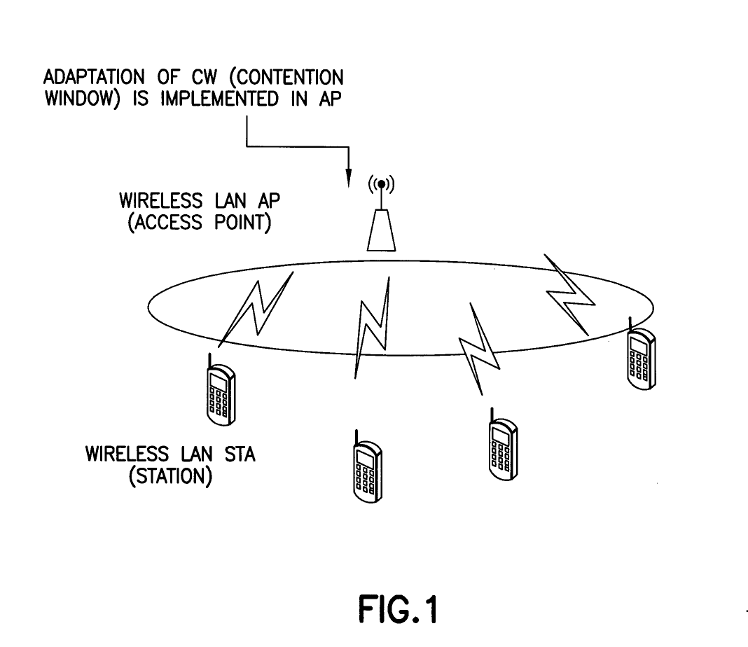

A wireless communication system for which the present invention works is shown in FIG. 1. In the system, a wireless LAN access point (AP) 100 can be accessed by a plurality of wireless LAN stations (STA) 200a, 200b, 200c, . . . , 200n through a communication network 300.

The algorithm according to the present invention to adaptively update contention windows (CW) is implemented in AP 100, and can be utilized under CSMA/CA (Carrier Sense Multiple Access with Collision Avoidance) and also under DCA (Differential Channel Access) which works based on CSMA/CA. Furthermore, it is adaptable under EDCA (Enhanced Distributed Channel Access) which achieves DCA and is defined in “Wireless LAN Medium Access Control (MAC) and Physical Layer (PHY) Specifications: Medium Access Control (MAC) Quality of Service (QoS) Enhancements, IEEE Std. 802.11e/D12.0 (November 2004)”. AP 100 announces updated CW sizes through beacon transmissions. In the followings, the algorithm according to the present invention is explained assuming that it is implemented under EDCA.

The wireless LAN medium access control (MAC) layer is implemented in both AP 100 and LAN stations (STA) 200a, 200b, . . . 200n.

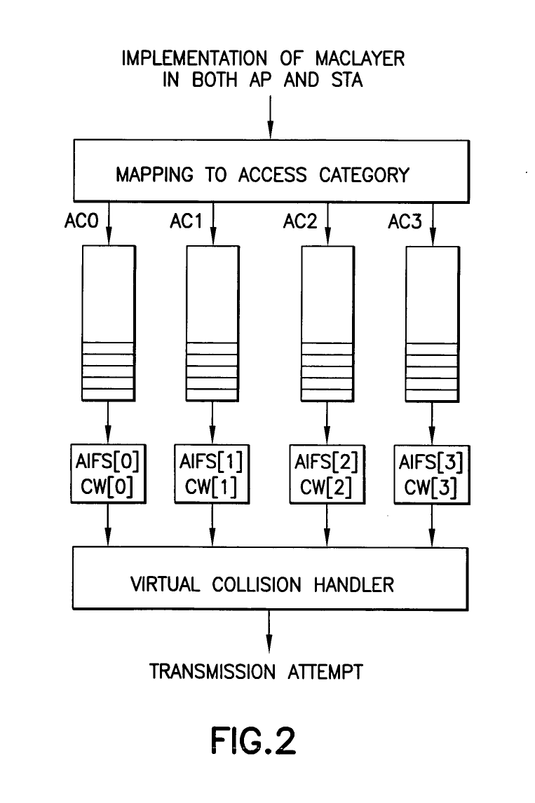

EDCA provides differentiated and distributed channel access to the WM based on 8 different UPs (user priorities). As shown in FIG. 2, the EDCA mechanism defines four ACs (access categories) to support differentiated channel access. The mapping from UPs to ACs is defined in “Wireless LAN Medium Access Control (MAC) and Physical Layer (PHY) Specifications: Medium Access Control (MAC) Quality of Service (QoS) Enhancements, IEEE Std. 802.11e/D12.0 (November 2004)”.

Differentiated channel access is achieved through varying the amount of time a station would sense the channel to be idle and the length of CW for a backoff. Four ACs use different values of AIFS (arbitration inter frame space), the minimum CW size and the maximum CW size. In this embodiment, for AC [k] (0≦k≦3), the minimum CW size is CWₘᵢₙ[k], the maximum CW size is CWₘₐₓ[k] and the arbitration inter frame space is AIFS[k]. Further the arbitration inter frame space number is AIFSN[k] and the short interface space is SIFS.

The relation between AIFS[k] and AIFSN[k] is as follows,
AIFS[k]=AIFSN [k]×slotTime+SIFSTime (1)
The AP announces CWₘᵢₙ[k], CWₘₐₓ[k] and AIFSN[k] as a part of EDCA parameter-set in beacon frames. Default EDCA parameters are shown in “Wireless LAN Medium Access Control (MAC) and Physical Layer (PHY) Specifications: Medium Access Control (MAC) Quality of Service (QoS) Enhancements, IEEE Std. 802.11e/D12.0 (November 2004)”. If one AC has a smaller AIFSN, CWₘᵢₙ[k], and CWₘₐₓ[k] than another AC, the AC can have a better chance to access the WM earlier.

FIG. 2 shows four transmission queues implemented in a STA. Each queue supports on AC. It behaves as a single EDCA entity, contends for the channel access, and independently starts its backoff procedure depending on its associated AC. When more than one AC within a STA has their backoff timers expire at the same time, the collision among them is treated in a virtual manner. The highest priority frame is chosen and transmitted, and the other queues increase values of CW and start their backoff. But, their retry counters are not incremented when virtual collisions occur.

However, even though, in a STA, high priority AC can have a better chance to access the WM than low priority one, collisions often happen when there are a lot of transmissions from other stations. Especially if there is a large number of high priority traffic, contentions between flows belonging to the same AC often occur and degrade throughput of real-time flows.

This phenomenon happens due to that the default CW sizes for higher AC presented in “Wireless LAN Medium Access Control (MAC) and Physical Layer (PHY) Specifications: Medium Access Control (MAC) Quality of Service (QoS) Enhancements, IEEE Std. 802.11e/D12.0 (November 2004)” are too small for the network to accommodate much high priority traffic. One solution to overcome this problem is to set larger values as default ones. But, larger CW makes larger channel access delay and reduces efficiency of bandwidth utilization even in case where the network has little real-time traffic. Therefore, CW sizes have to be adaptively selected according to network conditions.

The 802.11e supports admission control to protect existing multimedia traffic both under EDCA and HCCA. Now, admission control method under EDCA is described.

The AP uses ACM (admission control mandatory) field in the EDCA parameter-set to indicate whether admission control is required for each AC. If admission control is needed for an AC, a STA has to send an ADDTS (add traffic stream) request frame to the AP. The ADDTS request contains TSPEC (traffic specification), such as mean data rate, nominal MSUD size, delay bound and etc.

When the AP receives an ADDTS request, it makes a determination as whether to accept or deny the request. If it accepts the request, it calculates from information conveyed in the request the amount of time for requested traffic to access the WM per one second, which is called medium time. Even though any algorithms can be used for deriving medium time, a recommended procedure is presented in “Wireless LAN Medium Access Control (MAC) and Physical Layer (PHY) Specifications: Medium Access Control (MAC) Quality of Service (QoS) Enhancements, IEEE Std. 802.11e/D12.0 (November 2004)”.

After calculating it, the AP sends to the STA and ADDTS response frame, which contains derived medium time. On receipt of the response from the AP, the STA adds medium time to a local variable, admitted_time, if the request is admitted. It also has another local variable, used_time. The used_time presents how long the STA has accessed the WM. Using the admitted_time and the used_time, the STA controls the channel access to the WM. The used_time are updated after each successful or unsuccessful MPDU (MAC protocol data unit) (re)transmission attempt as follows,
used_time=used_time+MPDUExchangeTime (2)

Further, at second interval,
used_time=max((used_time−admitted_time),0) (3)

MPDUExchangeTime is the duration needed to transmit one data frame, considering the duration of SIFS or the acknowledgement (ACK) transmission. If used_time reaches or exceeds the admitted_time, the corresponding AC cannot transmit any frames using its EDCA parameter-set until the used_time is reset.

Admission control mechanism is very important for protecting the existing multimedia traffic from other real-time traffic. However, even if admission control is used for multimedia traffic, the traffic can be disturbed by best effort traffic.

### First Embodiment

Now, algorithm according to the first embodiment of the present invention to dynamically control EDCA parameters (i.e. CW sizes) in order to protect high priority traffic is shown. First, an analytical throughput and delay model under EDCA is shown, based on “An Admission Control Strategy for Differentiated Services in IEEE 802.11 (Yu-Kiang Kuo, Chi-Hung Lu, Eric Hsiao-Kuang, and Gen-Huey Chen, Globecom 2003, December 2003)” and “Performance analysis of the IEEE 802.11 distributed coordination function (G. Bianchi, IEEE Journal of Selected Areas on Communication Vol. 18, no. 3, pp. 785-799, December 2000)”.

It is assumed that a STA has K traffic classes with distinct QoS requirement. Using renewal theory, throughput of a flow in queue k(0≦k≦K−1) for one transmission cycle can be expressed as:

$$ρ [ k ] = \frac{\overline{L [ k ]}}{E [ {T}_{k} ]} \qquad ( 4 )$$

\overline{L[k]} is the average length of a frame in a class k. E[Tₖ] denotes the average transmission cycle, which consists of the average length of idle periods resulting from backoff, some unsuccessful periods, (due to collision and error), and a successful period. It is expressed as follows:
E[Tₖ]=E[CNₖ](δ\overline{TBₖ}+τ+T_{SIFS}+AIFSₖ+T_{RTS}+H)+δ\overline{TBₖ}+E[Sₖ] (5)
In this equation, \overline{TBₖ} is the averaged backoff time of a flow in a class k, E[CNₖ] denotes the average number of collisions occurred in a class k, T_{SIFS} shows the length of SIFS period, T_{RTS} and H presents time needed to transmit RTS (Request to Send) and frame header, r is propagation delay, and E[Sₖ] is expressed as shown in equation (6).
E[Sₖ]=(T_{RTS}+T_{CTS}+T_{ACK}+4T_{SIFS}+4τ+Lₖ/M+AIFSₖ+H) (6)
In equation (6), Lₖ is length of data frame, M denotes data transmission rate, and T_{CTS} and T_{ACK} are transmission time of CTS and ACK, respectively. Using averaged backoff time in a class k, \overline{TBₖ}, the probability that a flow in a class k will transmit in a given time slot is:

$${q}_{k} = \frac{1}{{\overline{TB}}_{k} + 1} \qquad ( 7 )$$

When assuming that there are n=(n₀, n₁, . . . , n_{K-1}) stations in each class, from equation (7), collision probability in a class k is calculated as

$${p}_{k} = 1 - {( 1 - {q}_{k} )}^{{n}_{k} - 1} {\prod }_{j = 0 , j \neq k}^{K - 1} {( 1 - {q}_{j} )}^{{n}_{j}} \qquad ( 8 )$$

\overline{TBₖ} is expressed using the number of collisions involved in a class k, CNₖ,

$$\overline{{TB}_{k}} = {\sum }_{l = 0}^{∞} \overline{{TB}_{{k}_{l}}} P \{ {CN}_{k} = l \} \qquad ( 9 )$$

The distribution of CNₖ is

$$P \{ {CN}_{k} = l \} = \{ \begin{matrix}{p}_{k}^{l} , ( l \geq 1 ) \\ 1 - {\sum }_{a = 1}^{∞} {p}_{k}^{a} , ( l = 0 )\end{matrix} \qquad ( 10 )$$

Then, \overline{TBₖ} is computed as

$$\overline{{TB}_{k}} = ( 1 - {\sum }_{a = 1}^{∞} {p}_{k}^{a} ) \frac{{CW}_{min k} + {AIFS}_{k}}{2} + {\sum }_{a = 1}^{∞} {p}_{k}^{a} \frac{{2}^{a} ( {CW}_{min k} + 1 ) + {AIFS}_{k} - 1}{2} \qquad ( 11 )$$

If α is beyond the maximum backoff stage, mₖ, of a class k, it is set to mₖ.

From equations (7) and (8), it is obviously expected that collision probability becomes low when the size of backoff counter is large. As a result, throughput increases. However, too large backoff counter generates large transmission delay and then throughput declines. Therefore, selecting optimum CW size results in enhancing throughput and maintaining transmission delay to a certain extent.

The service differentiation defined in the 802.11e is that traffic in higher AC can have a better opportunity to access the medium than one in lower AC. The policy of the present invention completely follows the policy used in 802.11e even when CW is updated. That is, minimum and maximum sizes of CW in an AC do not become smaller than those in higher ACs. Table 1 shows default EDCA parameters defined in 802.11e.

TABLE 1
Default EDCA Parameters

| AC | | | |
|---|---|---|---|
| # | CWₘᵢₙ | CWₘₐₓ | AIFSN |
| 0 | aCWₘᵢₙ | aCWₘₐₓ | 7 |
| 1 | aCWₘᵢₙ | aCWₘₐₓ | 3 |
| 2 | $\frac{{aCW}_{min} + 1}{2} - 1$ | aCWₘᵢₙ | 2 |
| 3 | $\frac{{aCW}_{min} + 1}{4} - 1$ | $\frac{{aCW}_{min} + 1}{2} - 1$ | 2 |

Adaptation of CW sizes is done for protecting traffic in AC2 and AC3. When CW sizes in AC2 and AC3 are updated, those in AC1 and AC0 are also updated to maintain at least service differentiations defined in Table 1.

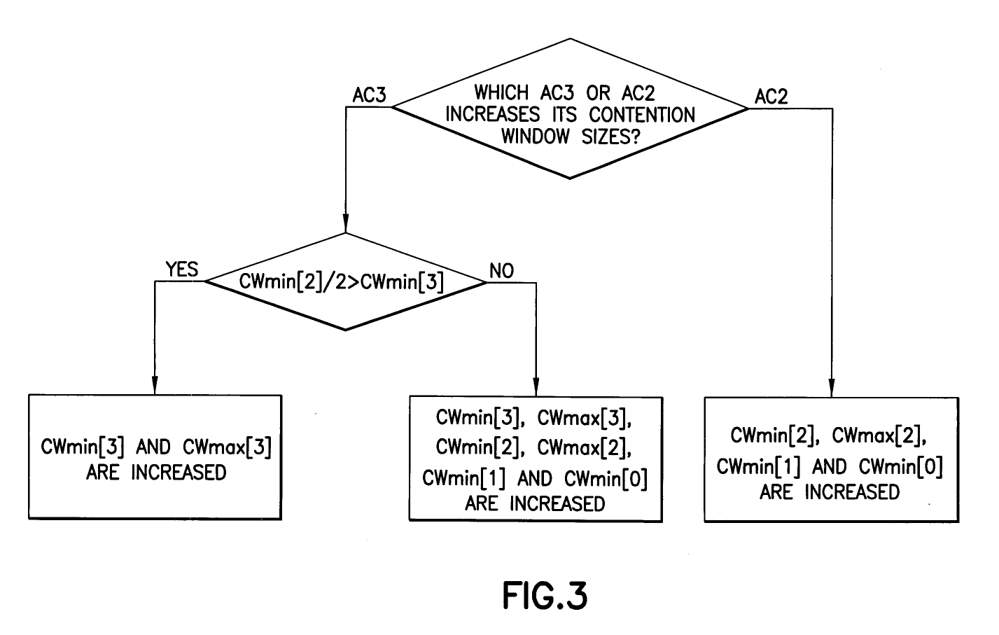

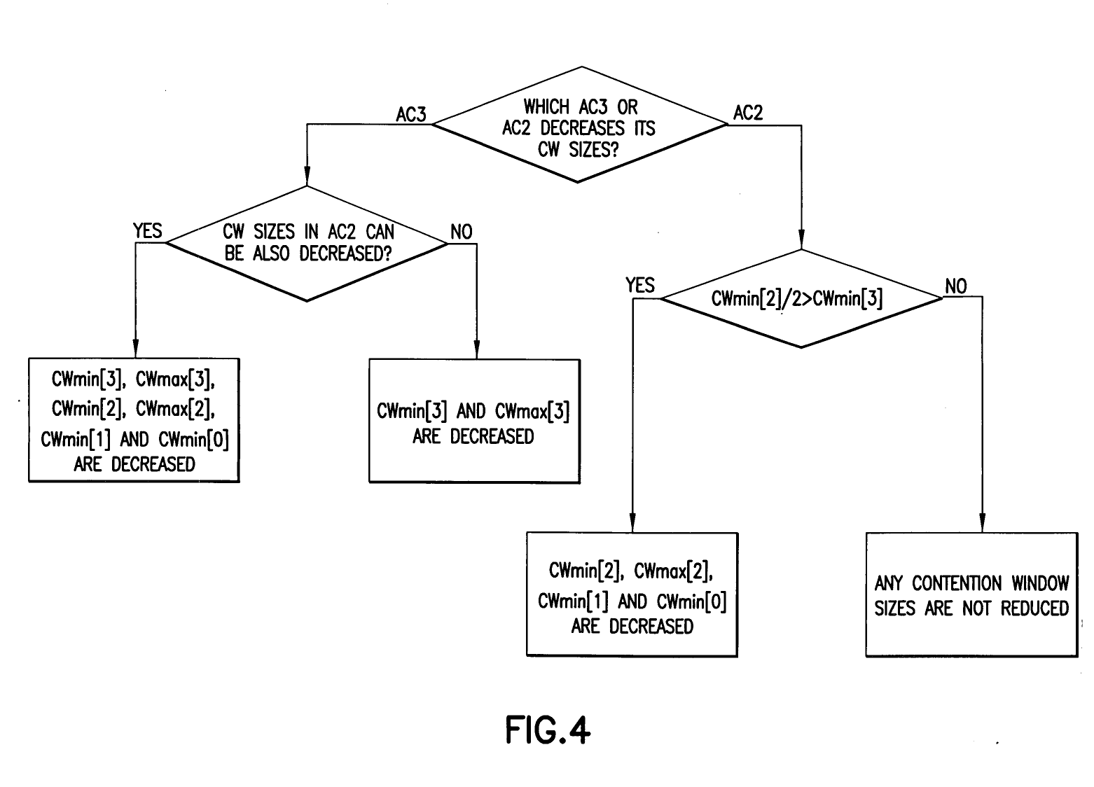

However, since default values of CWₘₐₓ[0] and CWₘₐₓ[1] are set to aCWₘₐₓ, both of them are not updated. FIG. 3 and FIG. 4 show update policies when increasing and decreasing CW sizes, respectively. For example, when increasing CW sizes in AC3, if half of those in AC2 are larger than the current ones in AC3, only CWₘᵢₙ[3] and CWₘₐₓ[3] are increased. Otherwise, CWₘᵢₙ[2], CWₘₐₓ[2], CWₘᵢₙ[1] and CWₘᵢₙ[0] are also increased in addition to ones in AC3.

Therefore, at least, service differentiations defined in Table 1 are maintained. That is, for example, CWₘᵢₙ[3] is expressed as

$$\frac{{aCW}_{min} + 1}{4} - 1$$

even when CW sizes in AC3 are increased. When decreasing CWₘᵢₙ[3] and CWₘₐₓ[3], CWₘᵢₙ[2], CWₘₐₓ[2], CWₘᵢₙ[1] and CWₘᵢₙ[0] are also decreased if CW sizes in AC2 can be decreased.

In case of increasing CW sizes in AC2, CWₘᵢₙ[1] and CWₘᵢₙ[0] are also increased in addition to ones in AC2. When decreasing them, if half of CWₘᵢₙ[2] is lager than CWₘᵢₙ[3], CWₘᵢₙ[2], CWₘₐₓ[2], CWₘᵢₙ[0] and CWₘᵢₙ[0] are decreased. When increasing CW sizes, they are not beyond the maximum value. When decreasing them, they do not become less than default values presented in Table 1.

The proposed algorithm is implemented in AP and adaptively controls CW sizes. If this algorithm assumes that network is saturated, it is known from equation (7) that if CW size set in an AC is smaller than the number of admitted flows, their transmissions always conflict with others.

However, in fact, whether a STA is ready to transmit a frame in a given time depends on packet arrival rates from upper layer. Even if the number of admitted flows is large, they can accept small CW size if their data rates are low. Therefore the algorithm takes care about whether a STA transmitting an admitted flow has frames in its transmission queue.

In 802.11e, the AP can know queue size of an admitted flow from QoS control field in MAC header. When a STA transmits a data frame, it sets its queue size in QoS control field in MAC header. In the proposed algorithm, the AP records the queue size upon receiving data frames from admitted flows. Before beacon transmission, the AP counts the number of STAs whose queue size is larger than zero, and runs the proposed algorithm to calculate optimum CW sizes. Decided CW sizes are contained in a beacon frame and then transmitted. Furthermore, the algorithm takes care about how long admitted flows have transmission delay if CW sizes are increased. If CW sizes become large, it may take long time for a flow to access the WM. Therefore, the algorithm estimates transmission delay of all admitted flows before it increases CW sizes, and if all estimated delay is lower than delay bound reported by TSPEC in ADDTS request, the AP can increase CW sizes.

To estimate transmission delay, the AP monitors how many collisions happened for admitted flows in AC2 and AC3 and stores those as running-average values (e.g. moving average). By using the averaged number of collisions and Eq. (5), transmission delay is estimated. In general, if CW sizes are increased, collision probability decreases. But, the averaged number of collisions happened in the current CW sizes is used even if transmission delay using increased CW sizes is estimated.

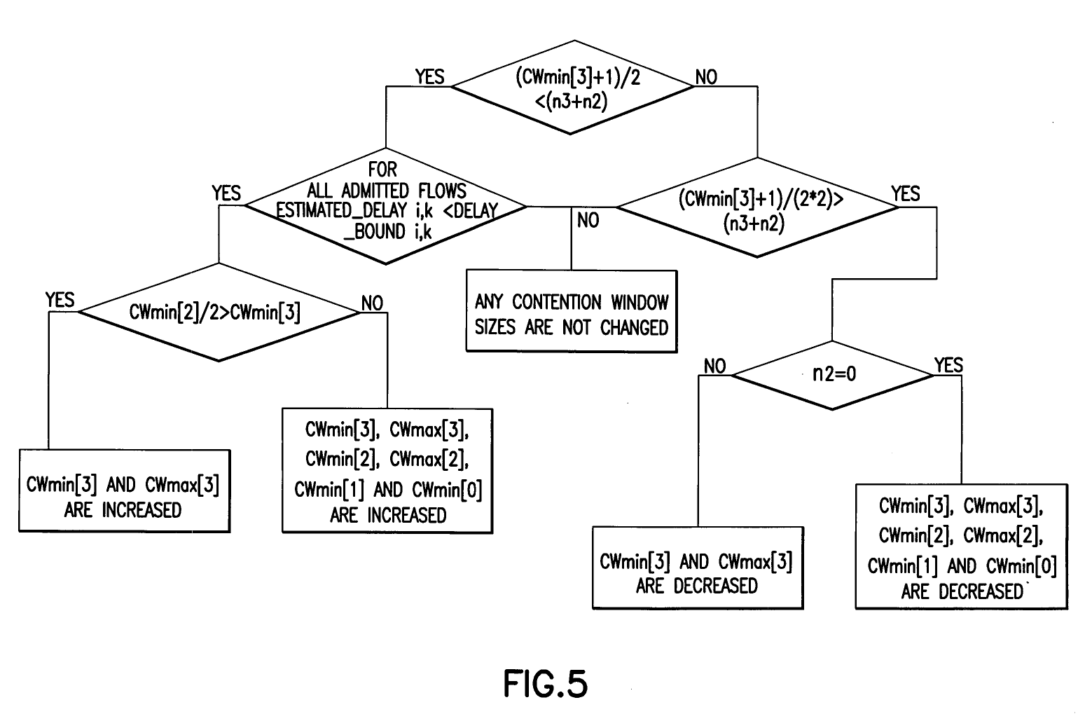

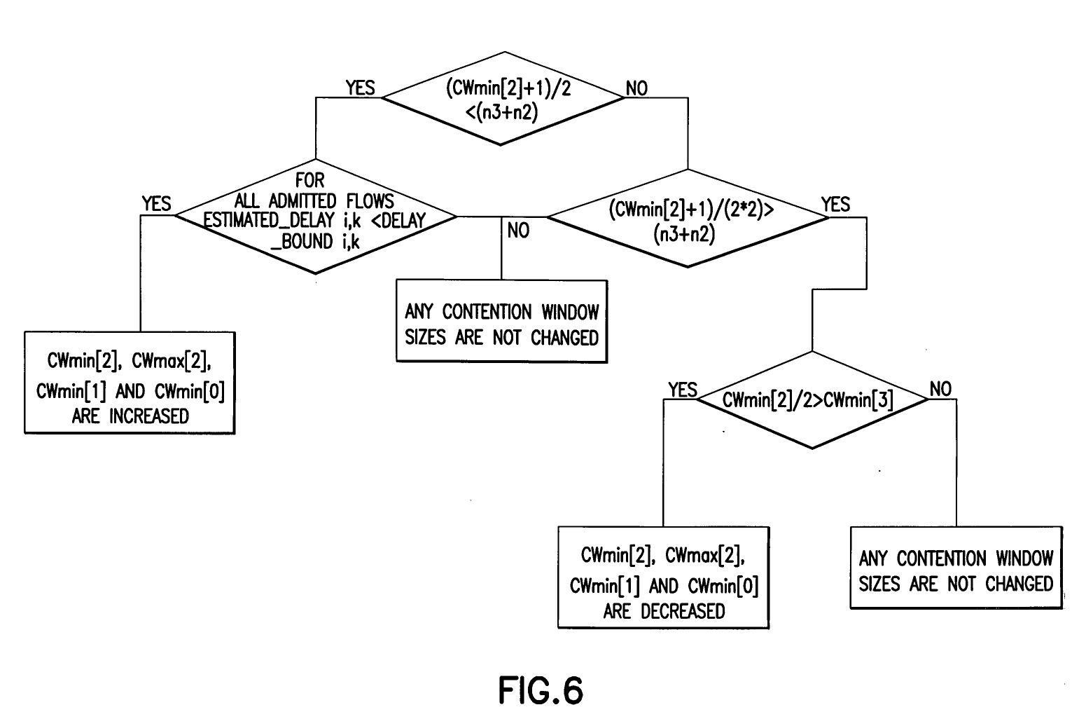

The algorithm has two phases. Flow charts in 1^{st} and 2^{nd} phases are shown in FIG. 5 and FIG. 6, respectively. It assumes that the number of flows whose queue size is larger than zero is nₖ for AC2 and AC3 (k=2 or 3), and the AP has already accepted gₖ flows in ACₖ. In FIG. 5 and FIG. 6, estimated delay and delay bound of flow i(0≦i≦gₖ) in AC k are expressed as estimated_delay_{i,k} and delay_bound_{i,k}, respectively.

Before beacon transmissions, the algorithm presented in 1^{st} phase is considered. If CW sizes in AC2 are updated in 1^{st} phase, algorithm presented in 2^{nd} phase is, next, processed.

### Second Embodiment

It should be well noted that the above mentioned algorithm in which the estimated transmission delay is taken into consideration is not always applied and the original algorithm without the transmission delay factors can be applied in accordance with traffic conditions.

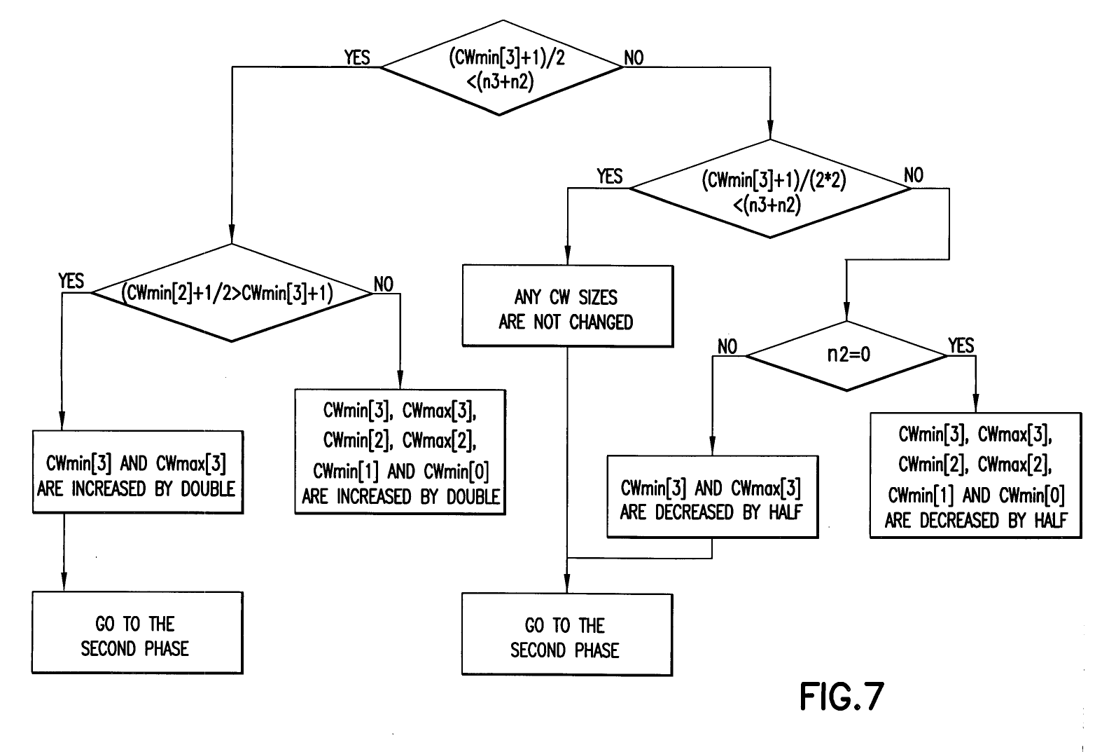

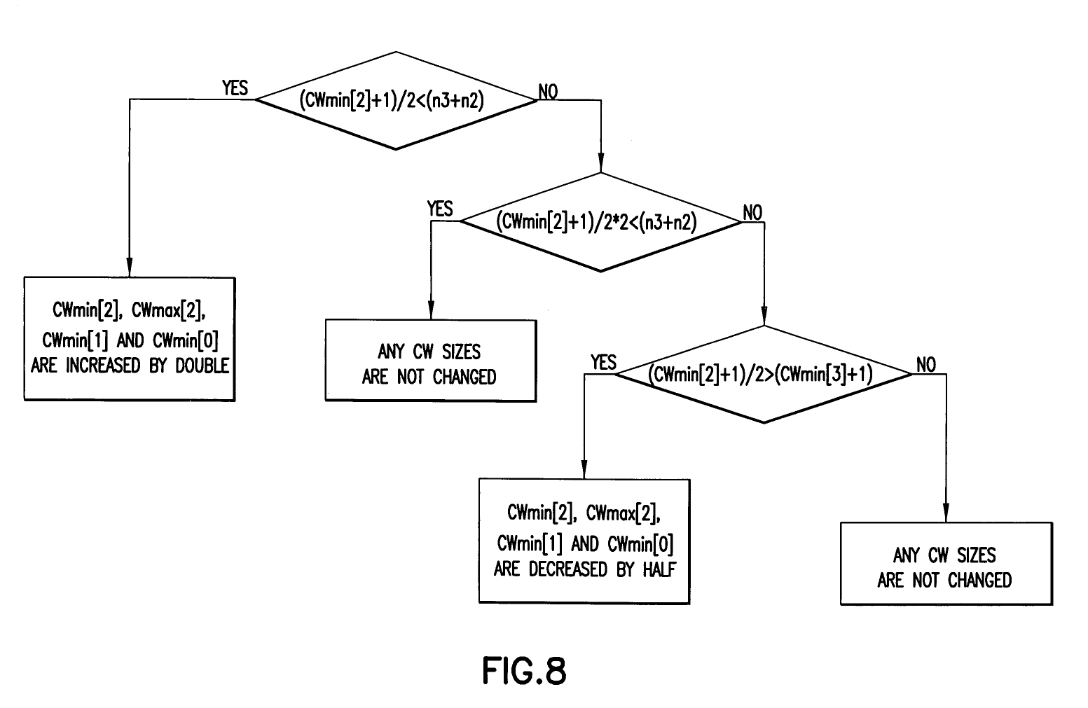

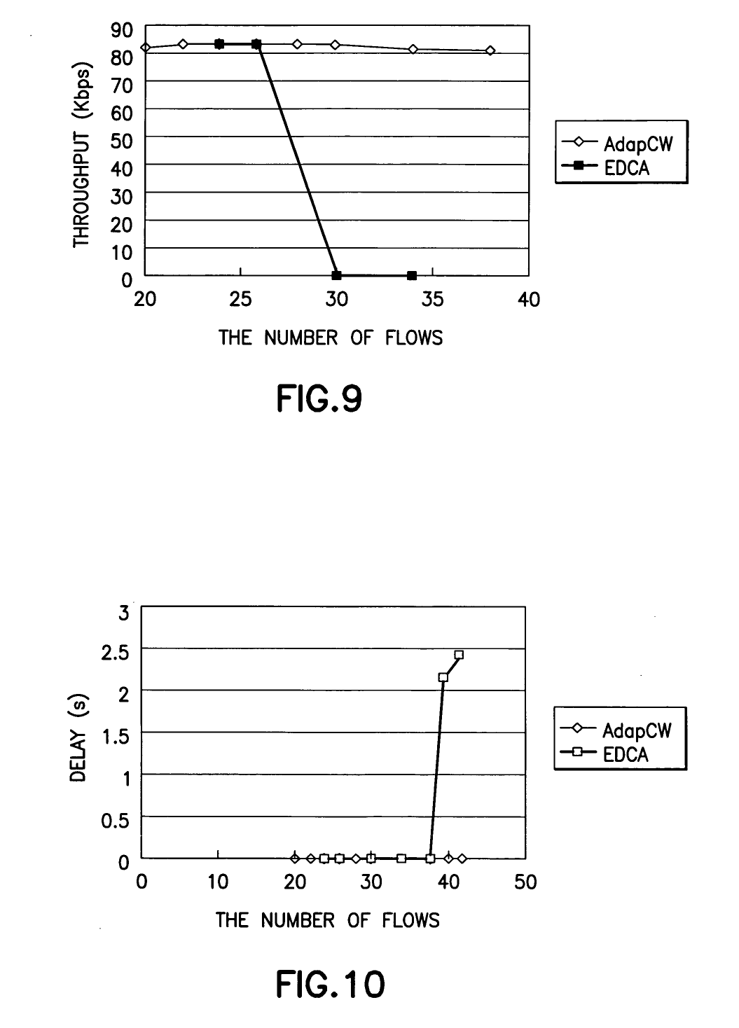

In the below, algorithm according to the second embodiment will be described. Algorithms in first and second phases are described in FIG. 7 and FIG. 8, respectively.

As similar to the algorithm presented in the first embodiment, the AP records the queue size upon receiving data frames from admitted flows. Before beacon transmission, the AP counts the number of STAs whose queue size is larger than zero, and runs the proposed algorithm to calculate optimum CW sizes.

Before beacon transmissions, the algorithm presented in 1st phase is first considered. The first phase deals with whether CW sizes in AC3 are increased or decreased. When they are increased or decreased, CW sizes in other ACs may be gained or reduced to maintain service differentiation defined as a default EDCA parameter-set. Only when CW sizes in AC2 are not changed in the first phase, the algorithm presented in the second phase is next considered.

Here, the algorithm in the first phase is presented. Collision probability is very related to the number of STAs, which are ready to transmit frames, and CW sizes. Therefore, taking into accout these two parameters, the algorithm makes a decision of whether CW sizes in AC3 are updated. Since CW sizes are adapted in order to reduce collisions between real-time traffic, it takes care about the number of STAs which are ready to transmit real-time frames, i.e. the sum of n3 and n2, as a key to update CW sizes in AC3. Besides it also focuses on the value of CWₘᵢₙ[3] because the value is definitely used in the initial backoff and if the value is small, collisions between real-time traffic in the AC often occur. Moreover, the average value of backoff counter of CWₘᵢₙ[3] is basically treated as the half of CWₘᵢₙ[3].

Hence the algorithm compares the half of CWₘᵢₙ[3] with the sum of n3 and n2. If it is smaller than the sum of n3 and n2, CW sizes in AC3 are increased to reduce collisions between real-time traffic. When they are increased, CW sizes in other ACs may have to be increased in order to maintain the service differentiation. In this case, the half of CWₘᵢₙ[2] is compared with CWₘᵢₙ[3] since CW sizes in AC3 must not be equal to or beyond CW sizes in AC2. If the half of CWₘᵢₙ[2] is larger than CWₘᵢₙ[3], only CWₘᵢₙ[3] and CWₘₐₓ[3] are increased by double. Otherwise CWₘᵢₙ[2], CWₘₐₓ[²], CWₘᵢₙ[1] and CWₘᵢₙ[0] are increased by double in addition to CWₘᵢₙ[3] and CWₘₐₓ[3]. On the other hand, when comparing the half of CWₘᵢₙ[3] with the sum of n3 and n2, if the half of CWₘᵢₙ[3] is larger than the sum of n3 and n2, CW sizes in AC3 will be possibly decreased because smaller CW sizes in AC3 may be acceptable for admitted real-time flows. To determine whether they can be reduced, (CWₘᵢₙ[3]+1)/(2*2) is compared with the sum of n3 and n2 since the half of the current CWₘᵢₙ[3] will be the value of CWₘᵢₙ[3] if CW sizes in AC3 can be decreased. In case where (CWₘᵢₙ[3]+1)/(2*2) is larger than the sum of n3 and n2, CW sizes in AC3 can be reduced. When reducing CW sizes in AC3 by half, those in other ACs will be able to be decreased. The number of admitted flows in AC2 is a key to decide it. If no admitted flow exists in AC2, CWₘᵢₙ[2], CWₘₐₓ[2], CWₘᵢₙ[1] and CWₘᵢₙ[0] are decreased by half in addition to CWₘᵢₙ[3] and CWₘₐₓ[3]. Otherwise, only CWₘᵢₙ[3] and CWₘₐₓ[3] are decreased by half.

If CW sizes in AC2 are not updated in 1st phase, the algorithm presented in 2nd phase is next processed. As similar to the algorithm presented in the 1st phase, the 2nd phase algorithm considers whether CW sizes in AC2 are increased or decreased, taking into account the number of STAs which are ready to transmit realtime traffic and the half of CWₘᵢₙ[2]. Hence, the half of CWₘᵢₙ[2] is first compared with the sum of n3 and n2. If it is smaller than the sum of n3 and n2, CW sizes in AC2 has to be increased to reduce collisions between real-time flows, and as explained in the previous subsection, CWₘᵢₙ[1] and CWₘᵢₙ[0] are accordingly increased to maintain the service differentiation. Otherwise they will be possibly decreased. To decide whether they are reduced, the algorithm considers whether the half of the current CWₘᵢₙ[2] is acceptable for real-time flows because it will be the value of CWₘᵢₙ[2] if CW sizes in AC2 can be decreased. Therefore (CWₘᵢₙ[2]+1)/(2*2) is first compared with the sum of n3 and n2. If (CWₘᵢₙ[2]+1)/(2*2) is larger than the sum of n3 and n2, CW sizes in AC2 will be possibly decreased. And then, the relation between CWₘᵢₙ[2] and CWₘᵢₙ[3] is next considered. If the half of CWₘᵢₙ[2] is equal to CWₘᵢₙ[3], CWₘᵢₙ[2] cannot be decreased because CW sizes in AC2 must not be equal to and smaller than those in AC3. In case where the half of CWₘᵢₙ[2] is larger than CWₘᵢₙ[3], CWₘₐₓ[2], CWₘₐₓ[2],CWₘᵢₙ[1] and CWₘᵢₙ[0] are decreased by half.

The proposed algorithm was implemented and the performance of multimedia flows with different channel loads was evaluated. Now, the proposed algorithm (referred as to AdapCW) for dynamic adaptation of CW sizes is evaluated, comparing with 802.11e EDCA (referred as to EDCA).

Both of them use admission control presented in “Wireless LAN Medium Access Control (MAC) and Physical Layer (PHY) Specifications: Medium Access Control (MAC) Quality of Service (QoS) Enhancements, IEEE Std. 802.11e/D12.0 (November 2004)”.

The relation between throughput or delay and the number of STAs are used to evaluate the invention. It is assumed that AP and STAs operate with IEEE 802.11a presented in “Wireless LAN Medium Access Control (MAC) and Physical Layer (PHY) Specifications: high-speed physical layer in the 5 GHz band, IEEE Std. 802.11a-1999”.

Physical data rate and basic rate are set to 12 Mbps and 6 Mbps, respectively. The beacon interval is set to 100 ms. Transmission queue size for each AC is set to 50. For each AC, it is set the following parameters: CWₘₐₓ[0]=1023, CWₘᵢₙ[0]=15; CWₘₐₓ[1]=1023, CWₘᵢₙ[1]=15; CWₘₐₓ[2]=15, CWₘᵢₙ[2]=7; CWₘₐₓ[3]=7, CWₘᵢₙ[3]=3; AIFSN[0]=7, AIFSN[1]=3, AIFSN[2]=2, AIFSN[3]=2.

Each voice flow is 83.2 Kbps, which is generated by a constant interval, 20 ms and has a fixed payload size of 208 bytes. This flow corresponds to G.711-coded VoIP presented in “Protection and Guarantee for Voice and Video Traffic in IEEE 802.11e Wireless LANs (Yang Xiao, Haizhon Li, and SunghyunChoi, INFOCOM2004, March 2004)”. Each video flow is 256 Kbps, which is generated by a constant interval, 20 ms and has a fixed payload size of 640 bytes.

The above simulations were performed to evaluate AdapCW compared to EDCA. Since the AdapCW focuses on reducing collisions between high priority flows, voice and video traffic are used for evaluating it. First, only VoIP scenario (Scenario1) is considered. FIG. 7 and FIG. 8 present comparisons of throughput and delay between AdapCW and EDCA.

When the number of flows increases, contentions between voice flows often occur. The default CW size for voice flow is too small to accept many voice flows due to frequent collisions. On the other hand, since AdapCW can increase CW sizes for voice traffic when considering buffer information transmitted in data frame, it can reduce collision and accept more voice flows than EDCA.

As for delay comparison in FIG. 10, it can be realized that frequent collisions generate large delay in EDCA and AdapCW decreases collision probability and maintains low delay.

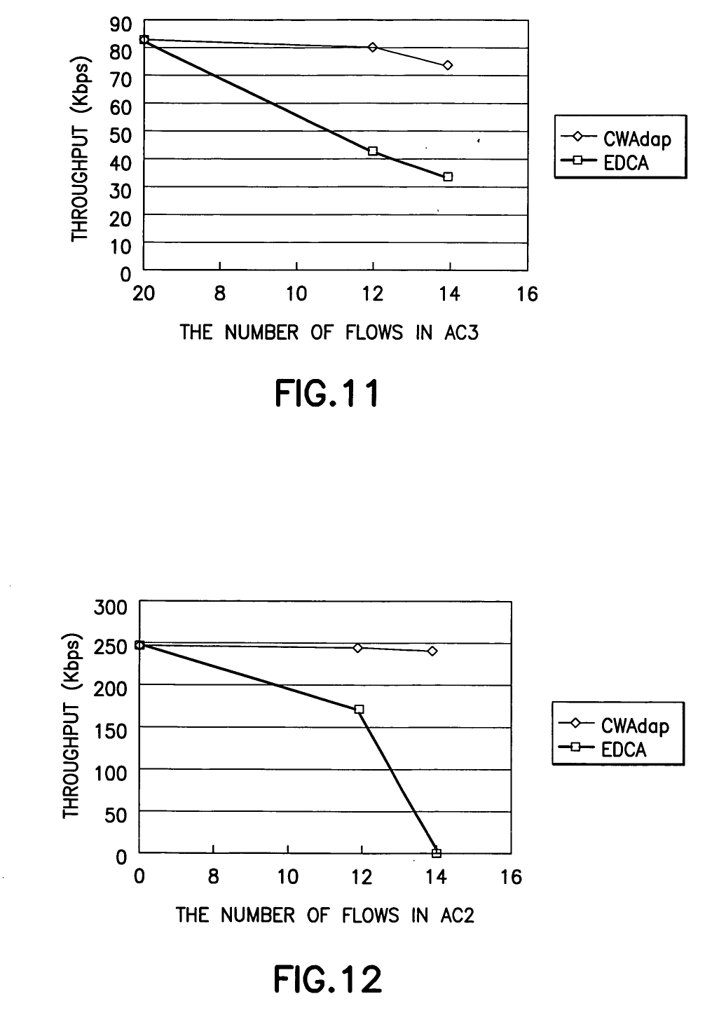

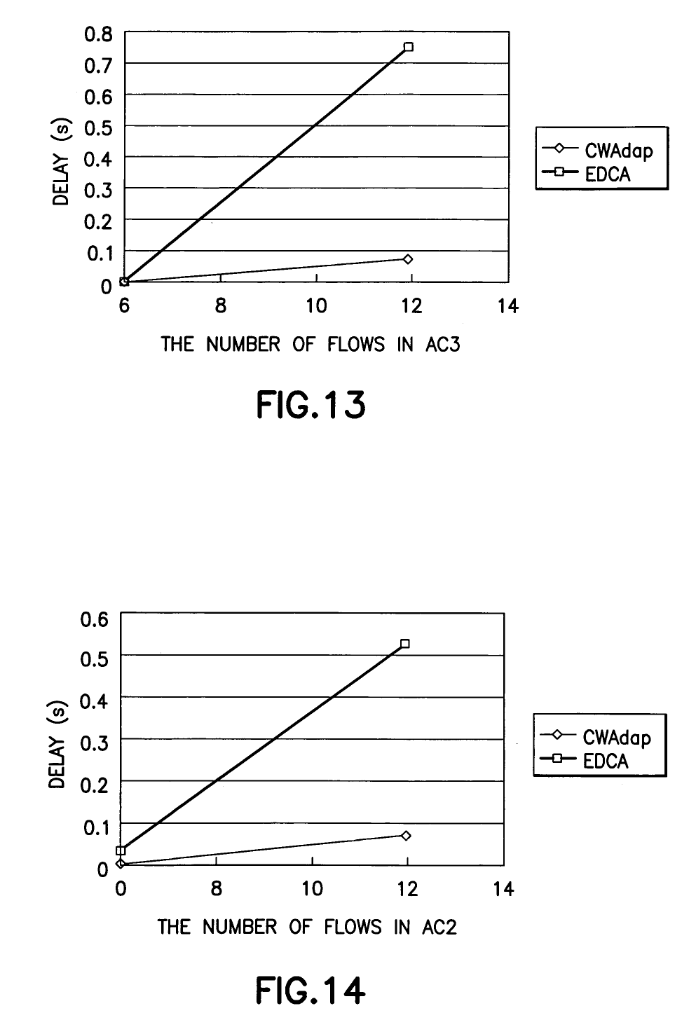

Next, a scenario where each STA has voice and video traffic (Scenario2) is considered. FIG. 11 and FIG. 12 show throughput of voice traffic and video traffic, respectively.

EDCA cannot maintain throughput of voice and video flows when traffic load increases. On the other hand, AdapCW can improve throughput degradation of real-time traffic, compared to EDCA. FIG. 11 and FIG. 12 present delay of voice and video traffic. We see that AdapCW can maintain delay to a certain extent.

From these results, it can be realized that default CW sizes for real-time traffic are too small to accept many flows under EDCA and they should be changed according to network conditions. In fact, the proposed AdapCW cares about STA's transmission queue size for real-time traffic and adaptively control CW sizes in order to reduce collisions between real-time flows. As a result, it can accept more real-time flows than EDCA.

Although this embodiment can achieve service differentiation using different sizes of CW, those default values given in 802.11e fully cannot meet requirements of real-time traffic.

The presented invention provides a method to adaptively control CW sizes in order to enhance throughput of real-time traffic even when an AP accept large number of real-time traffic. Through computer simulations it could be realized that the proposed method could support QoS and accommodate larger number of real-time traffic compared to EDCA.

In the above embodiments, admission control mechanisms and just used admission control method presented in “Wireless LAN Medium Access Control (MAC) and Physical Layer (PHY) Specifications: Medium Access Control (MAC) Quality of Service (QoS) Enhancements, IEEE Std. 802.11e/D12.0 (November 2004)” was not evaluated. However, they most likely influence performance measures, such as throughput or delay.

In the aforementioned embodiments, the wireless LAN access point (AP) is accessed by a plurality of wireless LAN stations (STA) under EDCA.

1. A communication method for a wireless medium under Carrier Sense Multiple Access with Collision Avoidance (CSMA/CA) characterized by adaptively updating a size of contention windows (CWs) in access categories (ACs) of the wireless medium in accordance with real-time traffic conditions.

2. The communication method set forth in claim 1, wherein said method is applied to under Differential Channel Access (DCA) that is defined to support Quality of Service (QoS); the DCA including Enhanced Distributed Channel Access (EDCA).

3. The communication method set forth in claim 1, wherein default values of minimum and maximum sizes (CWₘᵢₙ, CWₘₐₓ) of the CWs in each ACs are set, when the wireless medium is turned on.

4. The communication method set forth in claim 3, wherein the default values are adaptively updated in accordance with the number of packets in each ACs.

5. A communication method for accessing between WLAN (Wireless LAN) devices and WLAN STAs (Stations) by adaptively updating minimum and maximum sizes (CWₘᵢₙ, CWₘₐₓ) of contention windows (CWs) in access categories (ACs) under Enhanced Distributed Channel Access (EDCA) in accordance with real-time traffic conditions, comprising steps of:
i) setting default values for CWₘᵢₙ[k] and CWₘₐₓ[k] in each AC[k], where k is an integer in a range of 0≦k≦3, when WLAN devices are turned on;
ii) counting the number of STAs having real-time flows whose transmission buffer is greater than zero;
iii) determining whether each size of CWs is necessary to be updated in accordance with the number of packets; and
iv) adaptively updating the size for each CWs when determined to be necessary and remaining the size for each CWs unchanged when determined to be unnecessary.

6. A communication method for accessing between WLAN (Wireless LAN) devices and WLAN STAs (Stations) by adaptively updating minimum and maximum sizes (CWₘᵢₙ, CWₘₐₓ) of contention windows (CWs) in access categories (ACs) under Enhanced Distributed Channel Access (EDCA) in accordance with real-time traffic conditions, comprising steps of:
i) setting default values for CWₘᵢₙ[k] and CWₘₐₓ[k] in each AC[k], where k is an integer in a range of 0≦k≦3, when WLAN devices are turned on;
ii) counting the number of STAs having real-time flows whose transmission buffer is greater than zero;
iii) determining whether each size of CWs is to be updated in accordance with an estimated transmission delay of all admitted traffics between the WLAN devices and the WLAN STAs; and
iv) adaptively updating the size for each CWs when determined to be necessary and remaining the size for each CWs unchanged when determined to be unnecessary.

7. The communication method set forth in claim 5, wherein in case of increasing CW sizes in AC[3], only CWₘᵢₙ[3] and CWₘₐₓ[3] are increased when CWₘᵢₙ[2]/2>CWₘᵢₙ[3] is satisfied and CWₘᵢₙ[3], CWₘₐₓ[3], CWₘᵢₙ[2], CWₘₐₓ[2], CWₘᵢₙ[1] and CWₘᵢₙ[0] are increased when CWₘᵢₙ[2]/2>CWₘᵢₙ[3] is not satisfied.

8. The communication method set forth in claim 5, wherein in case of increasing CW sizes in AC[2], CWₘᵢₙ[2], CWₘₐₓ[2], CWₘᵢₙ[1] and CWₘᵢₙ[0] are increased.

9. The communication method set forth in claim 7, wherein CWₘₐₓ[1] and CWₘₐₓ[0] are not updated because their default values are set as a maximum value.

10. The communication method set forth in claim 5, wherein in case of decreasing CW sizes in AC[3], CWₘᵢₙ[3], CWₘₐₓ[3], CWₘᵢₙ[2], CWₘₐₓ[2], CWₘᵢₙ[1] and CWₘᵢₙ[0] are decreased if CW sizes in AC[2] can be also decreased and only CWₘᵢₙ[³] and CWₘₐₓ[³] are decreased if CW sizes in AC[2] can not be decreased.

11. The communication method set forth in claim 5, wherein in case of decreasing CW sizes in AC[2], CWₘᵢₙ[2], CWₘₐₓ[2], CWₘᵢₙ[1] and CWₘᵢₙ[0] are decreased when CWₘᵢₙ[2]/2>CWₘᵢₙ[3] is satisfied and no CW sizes are decreased when CWₘᵢₙ[2]/2>CWₘᵢₙ[3] is not satisfied.

12. The communication method set forth in claim 10, wherein the decreased CW sizes are not below the default values of CWₘᵢₙ[k].

13. A wireless communication device operable under Carrier Sense Multiple Access with Collision Avoidance (CSMA/CA), comprising:
i) means for setting default size values for contention windows (CWs) in each access categories (ACs) when WLAN devices are turned on;
ii) means for adaptively updating the default size values in accordance with the number of packets in each ACs.

14. The communication method set forth in claim 13, wherein said method is applied to under Differential Channel Access (DCA) that is defined to support Quality of Service (QoS); the DCA including Enhanced Distributed Channel Access (EDCA).

15. A communication system for accessing between WLAN (Wireless LAN) devices and WLAN STAs (Stations) by adaptively updating minimum and maximum sizes (CWₘᵢₙ, CWₘₐₓ) of contention windows (CWs) in access categories (ACs) under Enhanced Distributed Channel Access (EDCA), comprising:
i) means for setting default values for CWₘᵢₙ[k] and CWₘₐₓ[k] in each AC[k], where k is an integer in a range of 0≦k≦3 when WLAN devices are turned on;
ii) means for examining ACs to search a number of packets therein;
iii) means for determining whether each size of CWs is necessary to be updated in accordance with the number of STAs having real-time flows whose transmission buffer is greater than zero; and
iv) means for adaptively updating the size for each CWs when determined to be necessary and remaining the size for each CWs unchanged when determined to be unnecessary.

16. The communication method set forth in claim 15, wherein said method is applied to under Differential Channel Access (DCA) that is defined to support Quality of Service (QoS); the DCA including Enhanced Distributed Channel Access (EDCA).
